(19) United States
(12) Patent Application Publication
(10) Pub. No.: US 2025/0136186 A1
(43) Pub. Date: May 1, 2025

(54) ROOF STRUCTURE OF VEHICLE

(71) Applicants: Hyundai Motor Company, Seoul (KR); Kia Corporation, Seoul (KR)

(72) Inventors: Byeongkyu Kwon, Hwaseong-si (KR); Jiae Yong, Hwaseong-si (KR); Hoyeon Kim, Hwaseong-si (KR)

(21) Appl. No.: 18/829,731

(22) Filed: Sep. 10, 2024

(30) Foreign Application Priority Data
Oct. 31, 2023 (KR) 10-2023-0148209

(51) Int. Cl. B62D 25/06; B60R 13/04; B62D 27/02

(52) U.S. Cl. CPC B62D 25/06; B60R 13/04; B62D 27/023

(57) ABSTRACT

An embodiment roof structure of a vehicle body configured to be assembled to a body complete assembly including side structures disposed on both sides of an under body is provided. The roof structure includes a roof side body configured to be disposed at an upper part of the side structure, a high roof module including a high roof panel disposed above the roof side body, and a roof mounting apparatus connecting the roof side body and the high roof module.

### CROSS-REFERENCE TO RELATED APPLICATIONS

This application claims the benefit of Korean Patent Application No. 10-2023-0148209, filed on Oct. 31, 2023, which application is hereby incorporated herein by reference.

### TECHNICAL FIELD

The present invention relates to a vehicle body.

### BACKGROUND

Recently, the vehicle industry has been introducing a new concept of future mobility vision to realize a human-centered, dynamic future city. One of these future mobility solutions is the purpose built vehicle (PBV), which is a purpose-based mobility.

An example of a PBV is an environment-friendly mobile vehicle based on an electric vehicle (EV). These PBVs can provide various customized services to users during the travel time from the origin to the destination through unmanned or manned autonomous driving.

The PBV's vehicle body can be configured in various shapes and sizes depending on the user's use case. For example, the vehicle body of a PBV can be used as a hailing or delivery type vehicle. The vehicle body of this PBV has a large area roof panel applied to the roof structure in order to provide users with a wide interior space.

Therefore, the design of a roof structure that can be applied to vehicle bodies of different specifications according to the user's various use cases is required.

The matters described in this background section are written to improve understanding of the background of embodiments of the invention and may include matters that are not already known prior art.

### SUMMARY

The present invention relates to a vehicle body. Particular embodiments relate to a roof structure of a vehicle body that can be applied to various vehicle bodies.

Embodiments of the present disclosure provide a roof structure for a vehicle body that is applicable to vehicle bodies of various vehicle types and can provide a wide indoor space to users.

A roof structure of a vehicle body assembled to a body complete assembly including side structures disposed on both sides of the under body, the roof structure according to an embodiment may include a roof side body provided at an upper part of the side structure, a high roof module including a high roof panel disposed above the roof side body, and a roof mounting unit that connects the roof side body and the high roof module.

The high roof module may further include a high roof side panel that is connected to both sides of the high roof panel and is connected to the roof side body.

The high roof module may be provided separately from the body complete assembly and may be connected to the roof side body through the roof mounting unit.

The roof side body may include a side outer panel, a roof side reinforcement member, and a roof side inner panel connected to each other.

The side outer panel, the roof side reinforcement member, and the roof side inner panel may be connected to each other through a side body welding portion, and the high roof side panel may be connected to the side body welding portion.

The roof structure according to an embodiment may include a roof side body provided at an upper part of the side structure, a high roof panel disposed above the roof side body, a high roof rail assembly connected to a lower surface of the high roof panel, and a high roof side panel that is connected to both sides of the high roof panel and is connected to the roof side body, respectively.

The high roof rail assembly may include a plurality of high roof rail members disposed spaced apart along the front-to-back direction of the vehicle body and connected to the high roof side panel and a plurality of spines disposed side by side along the front-to-back direction of the vehicle body to connect the high roof rail members.

The high roof rail assembly may include at least one spine connection member connecting the spines along the vehicle width direction and a plurality of rib members connecting the spines and the high roof side panel along the vehicle width direction.

The high roof side panel may be connected along the vertical direction to the high roof rail assembly and the roof side body to separate the interior and the exterior of the vehicle body.

The roof structure according to an embodiment may further include a plurality of roof mounting brackets connected to the roof side body and connected to the high roof side panel.

The roof mounting bracket may include a first part connected to the roof side body and a second part that extends from the first part and is connected to the high roof side panel.

The roof side body may include a side outer panel, a roof side reinforcement member, and a roof side inner panel connected to each other. The side outer panel, the roof side reinforcement member, and the roof side inner panel may be connected to each other through a side body welding portion, and the first part may be connected by welding to the lower part of the side body welding portion.

The high roof side panel may include a connection flange connected to the roof side body.

The roof side body may include a side outer panel, a roof side reinforcement member, and a roof side inner panel connected to each other. The side outer panel, the roof side reinforcement member, and the roof side inner panel may be connected to each other through a side body welding portion, and the connection flange may be connected by welding to the upper part of the side body welding portion.

A loading area may be formed between the roof mounting bracket and the side body welding portion, and the connection flange may be loaded into the upper part of the side body welding portion through the loading region.

The roof structure according to an embodiment may further include a front body roof rail member connected to the front of the roof side body in the vehicle width direction and connected to the high roof rail assembly and a rear body roof rail member connected to the rear of the roof side body in the vehicle width direction and connected to the high roof rail assembly.

The front body roof rail member and the rear body roof rail member may be formed in an ‘L’ cross-section shape.

The roof structure according to an embodiment may further include a plurality of garnish mounting brackets connected to the high roof side panel and a garnish panel connected to the garnish mounting brackets.

The garnish mounting brackets may be connected to the high roof rail assembly and the roof mounting brackets by three-layers welding with the high roof side panel in between.

According to an embodiment of the roof structure of a vehicle body, the high roof module is commonly applied to the body complete assembly manufactured in various shapes depending on the vehicle type, so the development period of a PBV can be shortened and the weight of the PBV can be reduced.

In addition, the effects that can be obtained or predicted from exemplary embodiments will be disclosed directly or implicitly in the detailed description of embodiments of the present invention. That is, various effects expected according to embodiments of the present invention will be disclosed in the detailed description to be described later.

### BRIEF DESCRIPTION OF THE DRAWINGS

Since these drawings are intended for reference in explaining exemplary embodiments of the present invention, the technical ideas of embodiments of the present invention should not be interpreted as being limited to the accompanying drawings.

FIG. 1 is a side view showing a roof structure of a vehicle body applied to the vehicle body according to an embodiment.

FIG. 2 is an exploded perspective view showing the roof structure of a vehicle body according to an embodiment.

FIG. 3 is an exploded perspective view showing a high roof module applied to the roof structure of a vehicle body according to an embodiment.

FIG. 4 is a perspective view showing a high roof rail assembly of the high roof module applied to the roof structure of a vehicle body according to an embodiment.

FIG. 5 is a perspective view showing the high roof rail assembly and a high roof side panel of the high roof module applied to the roof structure of a vehicle body according to an embodiment.

FIG. 6 is an exploded perspective view showing a roof mounting unit applied to the roof structure of a vehicle body according to an embodiment.

FIG. 7 is an exploded perspective view showing the roof mounting unit applied to the roof structure of a vehicle body according to an embodiment.

FIG. 8 is a cross-sectional view along line A-A in FIG. 1.

FIG. 9 is a cross-sectional view along line B-B in FIG. 6.

FIG. 10 to FIG. 12 are partial exploded perspective views showing garnish mounting brackets and garnish panels applied to the roof structure of a vehicle body according to an embodiment.

FIG. 13 is a cross-sectional view along line C-C in FIG. 10.

FIG. 14 is a cross-sectional view along line D-D in FIG. 10.

FIG. 15 is a cross-sectional view along line E-E in FIG. 10.

The following reference identifiers may be used in connection with the drawings to describe various features of embodiments of the present disclosure.

| | |
|---|---|
| 10: vehicle body | 11: under body |
| 13: side structure | 15: body complete assembly |
| 20: roof side body | 21: side outer panel |
| 23: roof side reinforcement member | 25: roof side inner panel |
| 27: side body welding portion | 29: loading region |
| 100: roof structure | 110: high roof module |
| 111: high roof panel | 113: bent portion |
| 121: high roof rail assembly | 123: high roof rail member |
| 125: spine | 127: spine connection member |
| 129: rib member | 131: high roof side panel |
| 133: connection flange | 151: garnish mounting bracket |
| 153: clip mating hole | 171: garnish panel |
| 173: clip | 210: roof mounting unit |
| 211: roof mounting bracket | 213: first part |
| 215: second part | 231: front body roof rail member |
| 251: rear body roof rail member | |

The drawings referenced above are not necessarily drawn to scale and should be understood as presenting a rather simplified representation of various preferred features illustrating the basic principles of embodiments of the invention. The specific design features of embodiments of the invention, including, for example, specific dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that those skilled in the art can easily implement the embodiments of the present invention. As those skilled in the art would realize, the described embodiments may be modified in various different ways, all without departing from the spirit or scope of the present invention.

The terminology used in this specification is for the purpose of describing specific exemplary disclosures and is not intended to limit the embodiments of the present invention. As used herein, singular forms are intended to also include plural forms, unless the context clearly indicates otherwise.

In addition, in the detailed description below, the names of the components are divided into first, second, etc. to distinguish them when the components are in a similar relationship, and the description below is not necessarily limited to that order.

The terms ‘comprising’ and/or ‘including’ as used in this specification indicate the presence of specified features, integers, steps, operations, elements, and/or components, but at least one other feature, integer, step, operation, element, and/or component may be present. It should also be understood that this does not exclude the presence or addition of steps, operations, components, and/or groups thereof.

As used in this specification, the term ‘and/or’ includes any one or all combinations of at least one associated listed item.

In this specification, the term ‘coupled’ or ‘connected’ means that components are directly connected to each other by welding, self piercing rivet (SPR), flow drill screw (FDS), structural adhesive, etc. or indirectly connected through at least one intermediary component, and indicates a physical relationship between two components.

The terms ‘vehicle,’ ‘of a vehicle,’ or other similar terms used in this specification are generally used in passenger automobiles, including passenger vehicles, sport utility vehicles (SUVs), buses, trucks, and various commercial vehicles, and also including hybrid vehicles, electric vehicles, hybrid electric vehicles, hydrogen power vehicles, and other alternative fuel vehicles (e.g., fuels derived from resources other than petroleum).

Hereinafter, exemplary embodiments of the present invention will be described in detail with reference to the accompanying drawings.

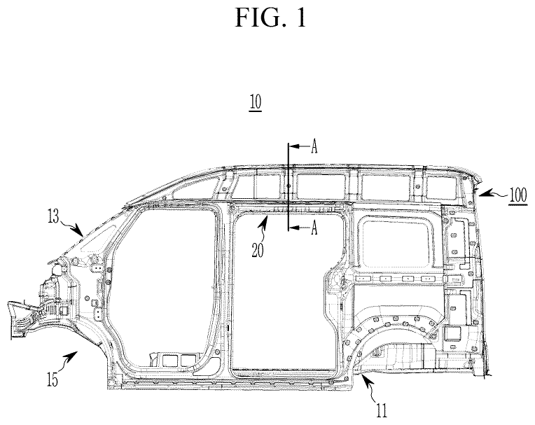

FIG. 1 is a side view showing a roof structure of a vehicle body applied to the vehicle body according to an embodiment.

Referring to FIG. 1, a vehicle body 10 to which a roof structure 100 according to an embodiment can be applied, for example, to a purpose-based mobility vehicle (Purpose Built Vehicle: hereinafter referred to as ‘PBV’).

The PBV can be used as an electric vehicle-based life module vehicle that provides various customized services to users during the travel time from the origin to the destination.

In one example, the PBV can be manufactured in a one box type design with a large interior space. Furthermore, the PBV can also apply facing type seats to the interior space. The PBV's vehicle body 10 can be manufactured in various shapes and sizes depending on the type of the PBV's customized service.

Furthermore, the vehicle body 10 of the PBV includes an under body 11, a side structure 13 respectively coupled to both sides of the under body 11, and the roof structure 100 according to an embodiment.

The under body 11, in one example, may be provided as a skateboard type. A person of ordinary skill in the art usually refers to the under body 11 as a ‘rolling chassis’ or ‘sash frame.’ The under body 11 may be equipped with components such as a battery assembly and a drive motor. And the side structure 13 is configured to form a cabin or luggage room with a large interior space inside the vehicle body 10.

The under body 11 and the side structure 13 combined together are referred to as a body complete assembly 15 in an embodiment.

The body complete assembly 15 can be applied to various vehicle types (or specifications). Various vehicle types refer to various configurations of the side structure 13, for example, a hailing vehicle as a means of transporting occupants, a delivery vehicle for transporting goods, and special vehicles such as an ambulance.

The side structure 13 may include a side door, window, etc. according to the required configuration depending on the type of vehicle.

A vehicle door, for example, a sliding door or a swing-type door, may be mounted on the side structure 13. However, depending on the vehicle type, the door may not be mounted on the side structure 13.

Additionally, a door window, for example, an open/closed door or fixed glass may be mounted on the side structure 13, or the window may not be mounted depending on the vehicle type.

The body complete assembly 15, which can be applied to various vehicle types, commonly includes a roof side body 20 provided on the upper part of the side structure 13.

In this specification, the ‘front-to-back direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

Furthermore, in this specification, ‘upper end,” upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The roof structure 100 of a vehicle body according to an embodiment may be mounted on the roof side body 20 of the side structure 13.

The roof structure 100 of a vehicle body according to an embodiment is configured to provide a wide interior space for the body complete assembly 15 of various vehicle types. The roof structure 100 according to an embodiment provides a structure applicable to the body complete assembly 15 of various vehicle types.

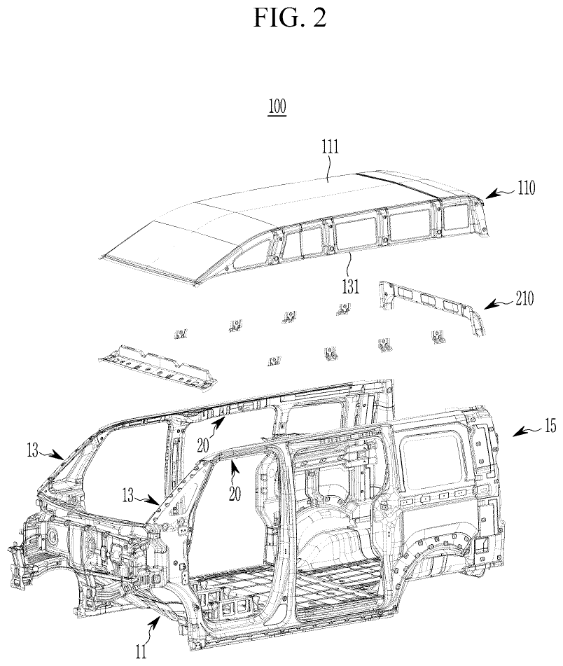

FIG. 2 is an exploded perspective view showing the roof structure of a vehicle body according to an embodiment.

Referring to FIG. 2, the roof structure 100 according to an embodiment includes a high roof module 110 and a roof mounting unit 210.

The high roof module 110 may be connected to the roof side body 20 of the side structure 13 to provide a wide interior space for the body complete assembly 15.

The high roof module 110 is a roof structure extending to a predetermined height along the height direction (e.g., upper direction) from the roof side body 20 disposed along the front-to-back direction of the vehicle body.

The high roof module 110 may further include function parts such as various operating systems of the PBV and roof glass (or sunroof glass).

The high roof module 110 is provided separately from the body complete assembly 15 and can be connected to the roof side body 20 through the roof mounting unit 210, which will be explained later.

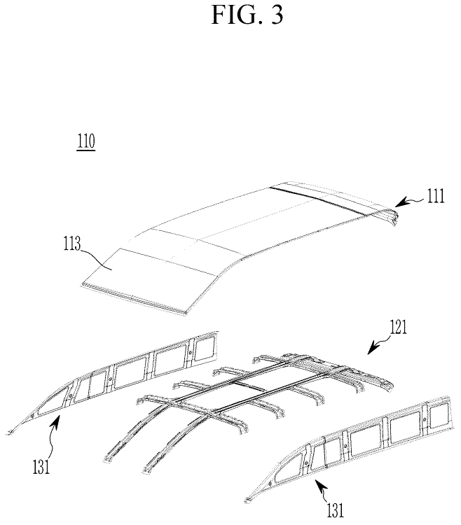

FIG. 3 is an exploded perspective view showing a high roof module applied to the roof structure of a vehicle body according to an embodiment.

Referring to FIG. 2 and FIG. 3, the high roof module 110 according to an embodiment includes a high roof panel 111, a high roof rail assembly 121, and a high roof side panel 131.

The high roof panel 111 is disposed above the roof side body 20 of the side structure 13. The high roof panel 111 may be provided as one panel or as at least two panels.

The high roof panel 111 may include a bent portion 113 that is inclined downward and curved from the center side of the roof side body 20 toward the front side of the vehicle body 10.

The high roof rail assembly 121 is configured to enhance the roof strength and vehicle body torsional strength of the high roof panel 111. The high roof rail assembly 121 is connected to the lower surface of the high roof panel 111.

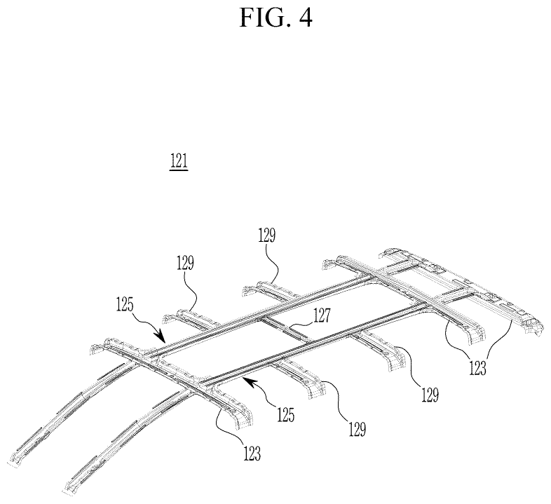

FIG. 4 is a perspective view showing a high roof rail assembly of the high roof module applied to the roof structure of a vehicle body according to an embodiment.

As shown in FIG. 4, the high roof rail assembly 121 includes a plurality of high roof rail members 123, a plurality of spines 125, at least one spine connection member 127, and a plurality of rib members 129.

The high roof rail members 123 are disposed to be spaced apart in the front-back direction of the vehicle body. Each of the high roof rail members 123 is disposed in the vehicle width direction.

In one example, the high roof rail members 123 may be provided in three pieces to partition the front, center, and rear portions of the high roof panel 111. However, it is not limited to this, and at least two or more high roof rail members may be disposed. In another example, the high roof rail members 123 may be formed in a ‘U’ cross-section shape.

The spines 125 are configured to connect the high roof rail members 123 along the front-to-back direction of the vehicle body. The spines 125 are disposed side by side along the front-to-back direction of the vehicle body at predetermined intervals along the vehicle width direction.

The spines 125 may be provided in at least two pieces. The drawing shows that two of the spines 125 are disposed, but the embodiments are not limited thereto, and three or more spines may be disposed.

The spine 125 may be formed as one member. Additionally, the spine 125 may be formed of a plurality of members separated along the front-to-back direction of the vehicle body.

The spine connection member 127 is configured to connect the spines 125 in the vehicle width direction. The spine connection member 127 is connected to the spines 125 through both ends. The drawing shows one spine connection member 127 disposed, but the embodiments are not limited thereto, and two or more spine connection members may be disposed.

The rib members 129 are configured to connect the spines 125 and the high roof side panel 131, which will be explained later, along the vehicle width direction. The rib members 129 are connected to the spines 125.

In the drawing, the rib members 129 are shown as two connected to each of the spines 125, but the embodiments are not limited to this, and one or three or more rib members 129 may be mounted on each of the spines 125.

The high roof side panel 131 is configured to compensate for the height difference between the roof side body 20 and the high roof panel 111. As shown in FIG. 2 and FIG. 3, the high roof side panel 131 is connected to both sides of the high roof panel 111 in the vehicle width direction.

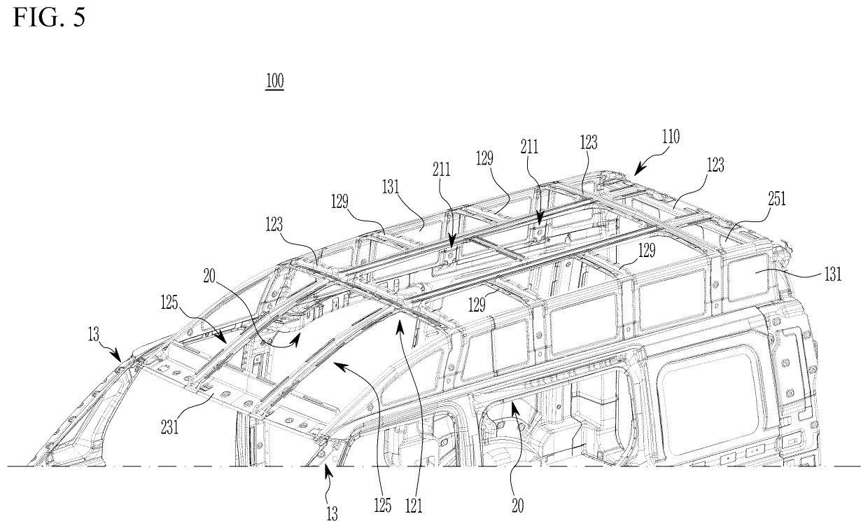

FIG. 5 is a perspective view showing the high roof rail assembly and a high roof side panel of the high roof module applied to the roof structure of a vehicle body according to an embodiment.

As shown in FIG. 5, the high roof side panel 131 is connected to the roof side body 20.

The high roof side panel 131 may be connected to both ends of the high roof rail members 123 and connected to the rib members 129. The high roof side panel 131 is connected to the high roof rail members 123, the rib members 129, and the roof side body 20 in the vertical direction to separate the interior and the exterior of the vehicle body 10.

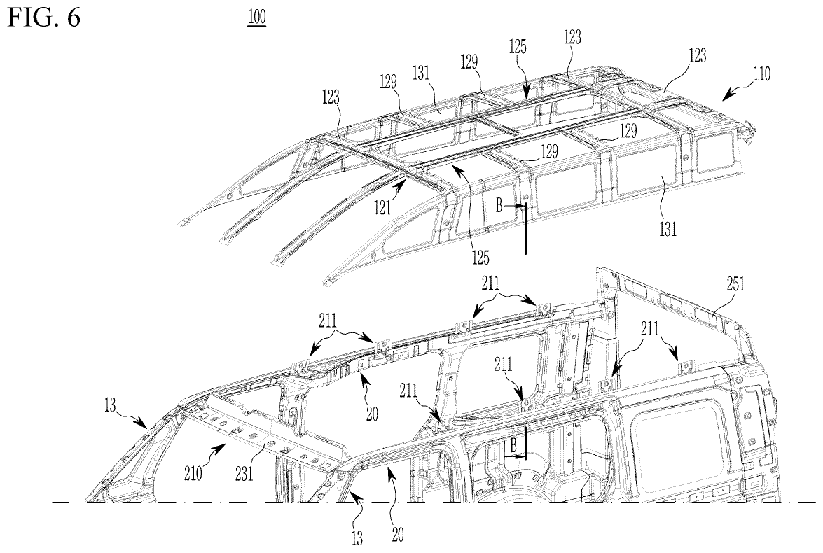

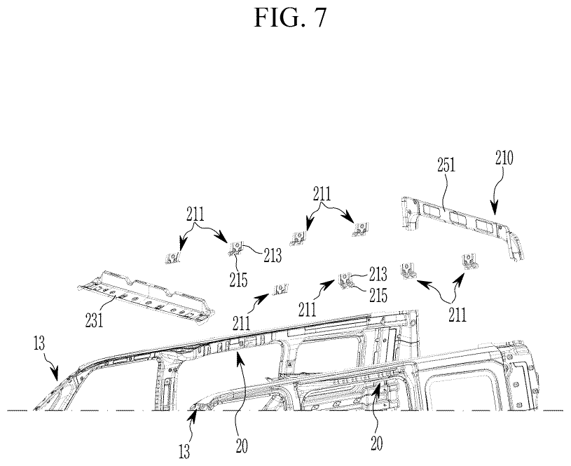

FIG. 6 is an exploded perspective view showing a roof mounting unit applied to the roof structure of a vehicle body according to an embodiment, and FIG. 7 is an exploded perspective view showing the roof mounting unit applied to the roof structure of a vehicle body according to an embodiment.

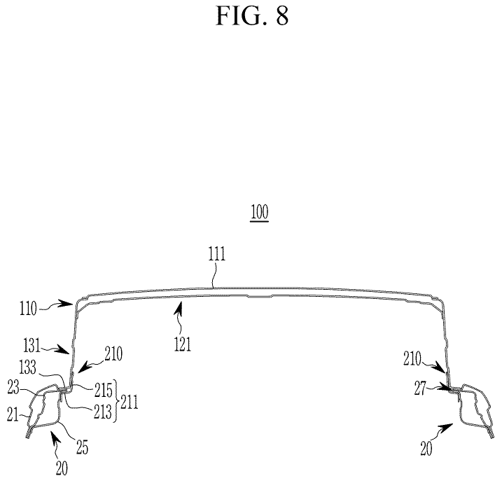

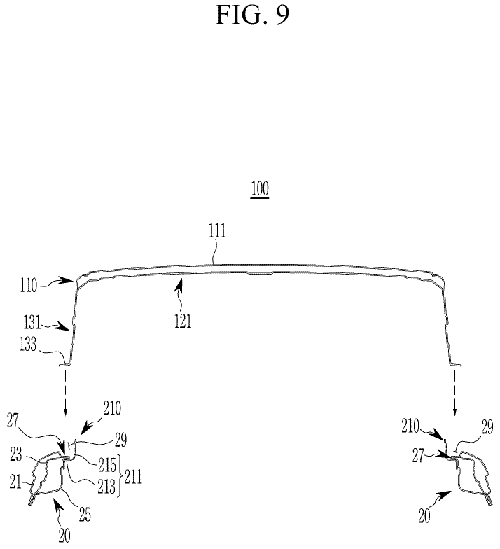

FIG. 8 is a cross-sectional view along line A-A in FIG. 1, and FIG. 9 is a cross-sectional view along line B-B in FIG. 6.

Referring to FIG. 5 to FIG. 9, the roof mounting unit 210 according to an embodiment is configured to connect the roof side body 20 and the high roof module 110.

The roof mounting unit 210 includes a plurality of roof mounting brackets 211, a front body roof rail member 231, and a rear body roof rail member 251.

The roof mounting brackets 211 are configured to connect the roof side body 20 and the high roof side panel 131. And the roof mounting brackets 211 are configured to support the high roof side panel 131 along the vehicle width direction and vertical direction.

The roof mounting brackets 211 are connected to the roof side body 20 and are connected to the high roof side panel 131. The roof mounting brackets 211 are disposed at positions corresponding to the high roof rail members 123 and the rib members 129 of the high roof rail assembly 121.

As shown in FIG. 8 and FIG. 9, the roof mounting bracket 211 includes a first part 213 and a second part 215.

The first part 213 is connected to the roof side body 20 in the vertical direction. And the second part 215 extends from the first part 213 and is connected to the high roof side panel 131 in the vehicle width direction.

The roof side body 20 includes a side outer panel 21, a roof side reinforcement member 23, and a roof side inner panel 25 that are coupled to each other. In addition, the side outer panel 21, the roof side reinforcement member 23, and the roof side inner panel 25 are connected to each other through a side body welding portion 27. The side body welding portion 27 may be formed as a welding portion in which the side outer panel 21, the roof side reinforcement member 23, and the roof side inner panel 25 are overlapped in three layers.

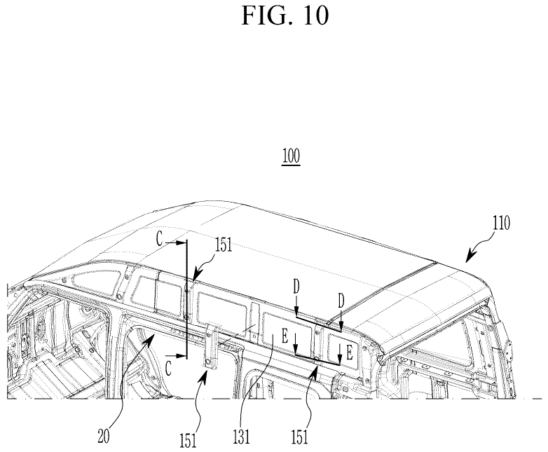

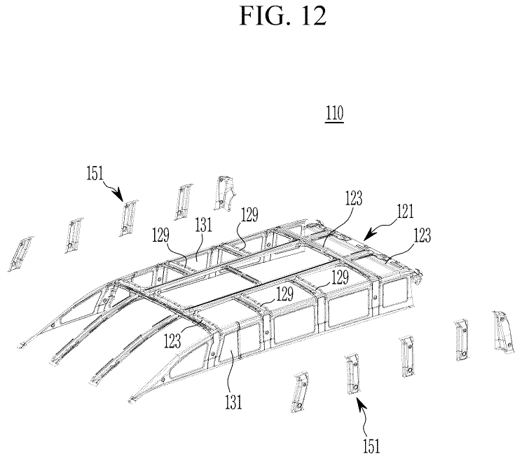

FIG. 10 to FIG. 12 are partial exploded perspective views showing garnish mounting brackets and garnish panels applied to the roof structure of a vehicle body according to an embodiment.

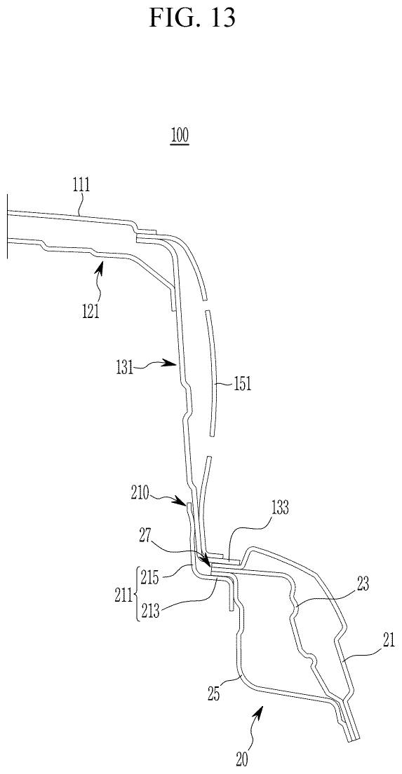

FIG. 13 is a cross-sectional view along line C-C in FIG. 10.

Referring to FIG. 13, the high roof side panel 131 includes a connection flange 133 formed at the lower part. The connection flange 133 may be connected to the roof side body 20. Furthermore, the connection flange 133 may be connected to the side body welding portion 27 of the roof side body 20.

The first part 213 of the roof mounting brackets 211 may be connected to the lower part of the side body welding portion 27 by welding. The second part 215 supports the high roof side panel 131 and may be connected to the inner surface of the high roof side panel 131 by welding. And the connection flange 133 of the high roof side panel 131 may be connected to the upper part of the side body welding portion 27 by welding.

As shown in FIG. 9, the connection flange 133 may be loaded on the upper part of the side body welding portion 27 through a loading region 29 formed between the second part 215 of the roof mounting brackets 211 and the side body welding portion 27.

Referring to FIG. 5 to FIG. 7, the front body roof rail member 231 and the rear body roof rail member 251 are configured to strengthen the upper strength of the side structure 13 and the torsional strength of the high roof module 110.

The front body roof rail member 231 is connected to the front of the roof side body 20 along the vehicle width direction. The front body roof rail member 231 is connected to the spines 125 of the high roof rail assembly 121. And the front body roof rail member 231 is connected to the high roof side panel 131.

The rear body roof rail member 251 is connected to the rear of the roof side body 20 along the vehicle width direction. The rear body roof rail member 251 is connected to the high roof rail member 123 on the rear side among the high roof rail members 123 of the high roof rail assembly 121. And the rear body roof rail member 251 is connected to the high roof side panel 131.

The front body roof rail member 231 and the rear body roof rail member 251 may be formed, in one example, in an ‘L’ cross-section shape to compensate for the height difference between the roof side body 20 and the high roof panel 111.

Referring to FIG. 10 to FIG. 13, the high roof module 110 according to an embodiment of the present invention may further include a plurality of garnish mounting brackets 151 and a garnish panel 171.

The garnish mounting brackets 151 are configured to mount the garnish panel 171 to the high roof side panel 131 while reinforcing the strength of the high roof side panel 131.

The garnish mounting brackets 151 are connected to the high roof side panel 131 and disposed along the vertical direction. Each of the garnish mounting brackets 151 may be placed in positions corresponding to the high roof rail members 123 and the rib members 129 of the high roof rail assembly 121.

The garnish mounting brackets 151 may be connected to the outside of the high roof side panel 131 by welding. And the garnish mounting brackets 151 may be connected to the high roof rail assembly 121 and the roof mounting brackets 211 by welding.

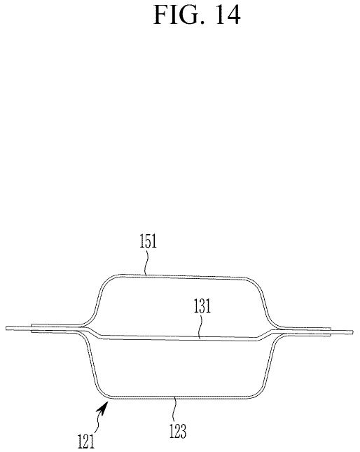

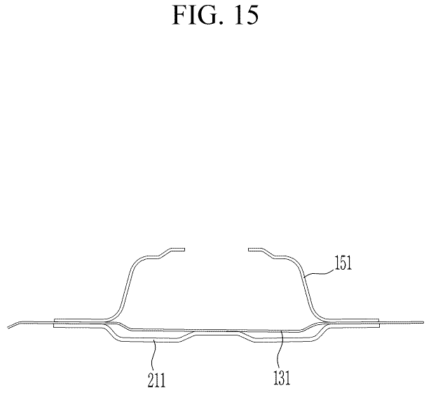

FIG. 14 is a cross-sectional view along line D-D in FIG. 10, and FIG. 15 is a cross-sectional view along line E-E in FIG. 10.

As shown in FIG. 14, the garnish mounting brackets 151 may be connected to the high roof rail members 123 with the high roof side panel 131 in between by three-layer welding.

As shown in FIG. 15, the garnish mounting brackets 151 may be connected to the roof mounting brackets 211 with the high roof side panel 131 in between by three-layer welding.

Therefore, the cross-section coefficient may be increased by the cross-section connection shape of the garnish mounting brackets 151, the high roof side panel 131, the high roof rail assembly 121, and the roof mounting brackets 211.

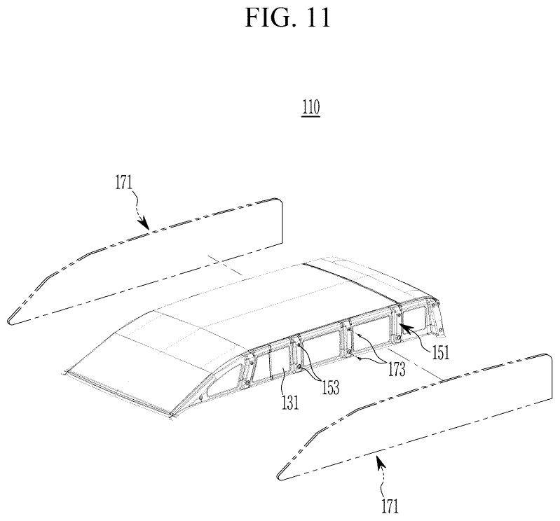

As shown in FIG. 11, the garnish panel 171 is connected to the garnish mounting brackets 151 to create a beautiful side appearance of the high roof module 110. In one example, the garnish panel 171 may be provided as a plastic injection molded product in various designs.

In another example, the garnish panel 171 may be connected to garnish mounting brackets 151 through clips 173. The clips 173 are mounted on the inner surface of the garnish panel 171 and may be connected to clip mating holes 153 formed to the garnish mounting brackets 151.

Hereinafter, referring to FIG. 1 to FIG. 15, the assembly process and operation of the roof structure 100 of a vehicle body according to an embodiment configured as described above will be described in detail.

The body complete assembly 15 assembled in the vehicle body assembly process is provided. The body complete assembly 15 includes the under body 11 and the side structures 13 connected to both sides of the under body 11.

The body complete assembly 15 may be manufactured in various shapes depending on the vehicle type. The body complete assembly 15 includes the roof side body 20 disposed on the upper part of the side structure 13 along the front-to-back direction of the vehicle body.

The roof side body 20 includes the side outer panel 21, the roof side reinforcement member 23, and the roof side inner panel 25 that are connected to each other. In addition, the roof side body 20 includes the side body welding portion 27 connecting the side outer panel 21, the roof side reinforcement member 23, and the roof side inner panel 25.

With the body complete assembly 15 as described above provided, the roof mounting brackets 211 of the roof mounting unit 210 are connected to the roof side body 20. The first part 213 of the roof mounting brackets 211 is connected to the lower part of the side body welding portion 27 by welding. Accordingly, the loading region 29 is formed between the second part 215 of the roof mounting brackets 211 and the side body welding portion 27.

And the front body roof rail member 231 of the roof mounting unit 210 is connected to the front of the roof side body 20 along the vehicle width direction. Additionally, the rear body roof rail member 251 of the roof mounting unit 210 is connected to the rear of the roof side body 20 along the vehicle width direction.

Meanwhile, the high roof module 110 assembled in the roof assembly process is provided. The high roof module 110 includes the high roof panel 111, the high roof rail assembly 121, and the high roof side panel 131 connected to each other. Furthermore, the high roof module 110 includes the garnish mounting brackets 151 connected to the high roof side panel 131.

Here, the components of the high roof module 110 as described above may be assembled in an in-line process using a conveyor. Accordingly, mass production of the high roof module 110 is possible.

In this state, the high roof module 110 is assembled into the body complete assembly 15, which is transported along the conveyor in a separate in-line process.

To specifically describe the assemble process of the body complete assembly 15 and the high roof module 110, the high roof side panel 131 of the high roof module 110 is loaded into the upper part of the side body welding portion 27 through the loading region 29 of the roof side body 20.

The connection flange 133 formed at the lower part of the high roof side panel 131 is loaded onto the upper part of the side body welding portion 27. And the second part 215 of the roof mounting brackets 211 supports the inner surface of the high roof side panel 131 along the vehicle width direction.

Next, the connection flange 133 is connected to the upper part of the side body welding portion 27 by welding, and the inner surface of the high roof side panel 131 is connected to the second part 215 of the roof mounting brackets 211 by welding.

Through a series of processes as described above, the vehicle body 10, in which the high roof module 110 is assembled into the body complete assembly 15, is transported along the conveyor in the assembly process. In this process, the garnish panel 171 is connected to the garnish mounting brackets 151.

Therefore, according to the roof structure 100 of a vehicle body according to an embodiment assembled as described above, the high roof module 110 can be mounted on the body complete assembly 15 of various vehicle types by the roof mounting unit 210.

The roof structure 100 of a vehicle body according to an embodiment can provide a wide interior space to the body complete assembly 15 by the high roof module 110.

In addition, according to the roof structure 100 of a vehicle body according to an embodiment, the high roof module 110 is commonly applicable to the body complete assembly 15 of various vehicle types.

To explain further, the high roof side panel 131 of the high roof module 110 is connected by welding to the side body welding portion 27 of the roof side body 20, which is commonly provided in the body complete assembly 15.

Accordingly, since the high roof module 110 is commonly applied to the body complete assembly 15 manufactured in various shapes according to the type of customized service of the PBV, the development period of the PBV can be shortened and the weight of the PBV can be reduced.

Therefore, the roof structure 100 of a vehicle body according to an embodiment does not require separate design and parts according to the type and needs of the PBV, and design and production costs can be reduced by applying common specifications and parts.

Furthermore, according to the roof structure 100 of a vehicle body according to an embodiment, the roof strength and vehicle body torsional strength can be increased by applying the high roof rail assembly 121 and the garnish mounting brackets 151 to the high roof module 110.

In addition, according to the roof structure 100 of a vehicle body according to an embodiment, since the high roof side panel 131 of the high roof module 110 separates the interior and exterior of the vehicle body 10, moisture is prevented from flowing into the interior of the vehicle body 10.

Furthermore, according to the roof structure 100 of a vehicle body according to an embodiment, the garnish mounting brackets 151 are coupled to the high roof rail assembly 121 and the roof mounting brackets 211 disposed on the inner side of the vehicle body with the high roof side panel 131 in between.

According to the roof structure 100 of a vehicle body according to an embodiment, the cross-sections of the garnish mounting brackets 151, the high roof side panel 131, the high roof rail assembly 121, and the roof mounting brackets 211 overlap sufficiently to ensure roof connectivity, thus lateral strength and collision performance can be enhanced.

While embodiments of this invention have been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A roof structure of a vehicle body configured to be assembled to a body complete assembly including side structures disposed on both sides of an under body, the roof structure comprising:
a roof side body configured to be disposed at an upper part of the side structure;
a high roof module comprising a high roof panel disposed above the roof side body; and
a roof mounting apparatus connecting the roof side body and the high roof module.

2. The roof structure of claim 1, wherein the high roof module further comprises a high roof side panel that is connected to both sides of the high roof panel and is connected to the roof side body.

3. The roof structure of claim 2, wherein the high roof module is provided separately from the body complete assembly and is connected to the roof side body through the roof mounting apparatus.

4. The roof structure of claim 2, wherein:
the roof side body comprises a side outer panel, a roof side reinforcement member, and a roof side inner panel connected to each other;
the side outer panel, the roof side reinforcement member, and the roof side inner panel are connected to each other through a side body welding portion; and
the high roof side panel is connected to the side body welding portion.

5. A roof structure of a vehicle body configured to be assembled to a side structure of the vehicle body, the roof structure comprising:
a roof side body configured to be disposed at an upper part of the side structure;
a high roof panel disposed above the roof side body;
a high roof rail assembly connected to a lower surface of the high roof panel; and
a high roof side panel connected to both sides of the high roof panel and connected to the roof side body, respectively.

6. The roof structure of claim 5, wherein the high roof rail assembly comprises:
a plurality of high roof rail members disposed spaced apart along a front-to-back direction of the vehicle body and connected to the high roof side panel; and
a plurality of spines disposed side by side along the front-to-back direction of the vehicle body and connecting the high roof rail members.

7. The roof structure of claim 6, wherein the high roof rail assembly comprises:
at least one spine connection member connecting the spines along a vehicle width direction; and
a plurality of rib members connecting the spines and the high roof side panel along the vehicle width direction.

8. The roof structure of claim 5, wherein the high roof side panel is connected along a vertical direction to the high roof rail assembly and the roof side body to separate an interior and an exterior of the vehicle body.

9. The roof structure of claim 5, further comprising a plurality of roof mounting brackets connected to the roof side body and connected to the high roof side panel.

10. The roof structure of claim 9, wherein each of the roof mounting brackets comprises:
a first part connected to the roof side body; and
a second part extending from the first part and connected to the high roof side panel.

11. The roof structure of claim 10, wherein:
the roof side body comprises a side outer panel, a roof side reinforcement member, and a roof side inner panel connected to each other;
the side outer panel, the roof side reinforcement member, and the roof side inner panel are connected to each other through a side body welding portion; and
the first part is connected by welds to a lower part of the side body welding portion.

12. The roof structure of claim 9, wherein the high roof side panel comprises a connection flange connected to the roof side body.

13. The roof structure of claim 12, wherein:
the roof side body comprises a side outer panel, a roof side reinforcement member, and a roof side inner panel connected to each other;
the side outer panel, the roof side reinforcement member, and the roof side inner panel are connected to each other through a side body welding portion; and
the connection flange is connected by welds to the upper part of the side body welding portion.

14. The roof structure of claim 13, wherein:
a loading area is defined between the roof mounting brackets and the side body welding portion; and
the connection flange is loaded into the upper part of the side body welding portion through the loading area.

15. The roof structure of claim 9, further comprising:
a front body roof rail member connected to a front of the roof side body in a vehicle width direction and connected to the high roof rail assembly; and
a rear body roof rail member connected to a rear of the roof side body in the vehicle width direction and connected to the high roof rail assembly.

16. The roof structure of claim 15, wherein the front body roof rail member and the rear body roof rail member have an ‘L’ cross-section shape.

17. The roof structure of claim 9, further comprising:
a plurality of garnish mounting brackets connected to the high roof side panel; and
a garnish panel connected to the garnish mounting brackets.

18. The roof structure of claim 17, wherein the garnish mounting brackets are connected to the high roof rail assembly and the roof mounting brackets by three-layers welding with the high roof side panel in between.

19. A vehicle body comprising:
an under body;
side structures disposed on both sides of the under body in a vehicle width direction and extending in a front-to-back direction of the vehicle body;
roof side bodies disposed at upper parts of the side structures, respectively, and extending in the front-to-back direction of the vehicle body;
a high roof module comprising a high roof panel disposed above the roof side bodies; and
a roof mounting apparatus connecting the roof side body and the high roof module.

20. The vehicle body of claim 19, wherein:
the high roof module further comprises a high roof side panel that is connected to both sides of the high roof panel and is connected to the roof side bodies;
each of the roof side bodies comprises a side outer panel, a roof side reinforcement member, and a roof side inner panel connected to each other through a side body welding portion; and
the high roof side panel is connected to the side body welding portion.
